(19) United States
(12) Patent Application Publication
(10) Pub. No.: US 2026/0339996 A1
(43) Pub. Date: Oct. 29, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Soma ONISHI, Tokyo (JP); Masanori Tsujikawa, Tokyo (JP); Daisaku Shibata, Tokyo (JP)

(73) Assignee: NEC Corporation, Tokyo (JP)

(21) Appl. No.: 19/533,454

(22) Filed: Feb. 9, 2026

(30) Foreign Application Priority Data
Feb. 19, 2025 (JP) 2025-025374

(51) Int. Cl. G06F 16/3329

(52) U.S. Cl. CPC G06F 16/33295

(57) ABSTRACT

Provided is an information processing technology with high inference accuracy. An information processing apparatus includes a first prompt generation unit for providing, to a large-scale language model, a first prompt for requesting to answer a question, a first message acquisition unit for acquiring a first message representing an answer to the question from the large-scale language model, a second prompt generation unit for providing, to the large-scale language model, a second prompt for requesting to re-answer the question using a reasonable inference method, and a second message acquisition unit for acquiring a second message representing a re-answer to the question from the large-scale language model.

### INCORPORATION BY REFERENCE

This application is based upon and claims the benefit of priority from Japanese patent application No. 2025-025374, filed on Feb. 19, 2025, the disclosure of which is incorporated herein in its entirety by reference.

### TECHNICAL FIELD

The present disclosure relates to an information processing apparatus, an information processing method, an information processing program, and an information processing system.

### BACKGROUND ART

A technique for analyzing information described in a natural language using a large-scale language model is widely used. In addition, development of an interface that enables more appropriate analysis by limiting an analysis target to information regarding a specific field is also in progress. For example, Medprompt is an interface of a Generative Pre-trained Transformer (GPT) specialized in the medical field (Nori, H., Lee, Y.T., Zhang, S., et al, “Can Generalist Foundation Models Outcompete Special-Purpose Tuning? Case Study in Medicine”, [online], 2023, [searched on 2025.02.19], see Internet <URL: http://arxiv.org/abs/2311.16452>).

### SUMMARY

However, even if Medprompt is used, there is a problem that the inference processing is unstable, and as a result, the inference accuracy is insufficient.

The present disclosure has been made in view of the above problems, and an example object thereof is to provide an information processing technique having high inference accuracy.

An information processing apparatus according to an example aspect of the present disclosure includes a first prompt generation means for generating a first prompt for requesting to answer a question and providing the generated first prompt to a large-scale language model, a first message acquisition means for acquiring a first message representing an answer to the question from the large-scale language model as a response to the first prompt, a second prompt generation means for generating a second prompt for requesting to re-answer the question using a reasonable inference method and providing the generated second prompt to the large-scale language model, and a second message acquisition means for acquiring a second message representing a re-answer to the question from the large-scale language model as a response to the second prompt.

An information processing method according to an example aspect of the present disclosure, in which at least one processor includes first prompt generation processing in which at least one processor generates a first prompt for requesting to answer a question and provides the generated first prompt to a large-scale language model, first message acquisition processing in which the at least one processor acquires a first message representing an answer to the question from the large-scale language model as a response to the first prompt, second prompt generation processing in which the at least one processor generates a second prompt for requesting to re-answer the question using a reasonable inference method and provides the generated second prompt to the large-scale language model, and a second message acquisition processing in which the at least one processor acquires a second message representing a re-answer to the question from the large-scale language model as a response to the second prompt.

An information processing program according to an example aspect of the present disclosure causes at least one processor to execute first prompt generation processing of generating a first prompt for requesting to answer a question and providing the generated first prompt to a large-scale language model, first message acquisition processing of acquiring a first message representing an answer to the question from the large-scale language model as a response to the first prompt, second prompt generation processing of generating a second prompt for requesting to re-answer the question using a reasonable inference method and providing the generated second prompt to the large-scale language model, and second message acquisition processing of acquiring a second message representing a re-answer to the question from the large-scale language model as a response to the second prompt.

An example advantage according to the above-described embodiments is that an information processing technology with high inference accuracy can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of an information processing apparatus according to the present disclosure;

FIG. 2 is a flowchart illustrating a flow of an information processing method according to the present disclosure;

FIG. 3 is a block diagram illustrating a configuration of an information processing apparatus according to the present disclosure;

FIG. 4 is a flowchart illustrating a flow of an information processing method according to the present disclosure;

FIG. 5 is a block diagram illustrating a configuration of an information processing apparatus according to the present disclosure;

FIG. 6 is a flowchart illustrating a flow of an information processing method according to the present disclosure;

FIG. 7 is a block diagram illustrating a configuration of an information processing apparatus according to the present disclosure;

FIG. 8 is a flowchart illustrating a flow of an information processing method according to the present disclosure;

FIG. 9 is a block diagram illustrating a configuration of an information processing apparatus according to the present disclosure;

FIG. 10 is a flowchart illustrating a flow of an information processing method according to the present disclosure; and

FIG. 11 is a block diagram illustrating a configuration of a computer that functions as the information processing apparatus according to the present disclosure.

### EMBODIMENTS

Hereinafter, example embodiments of the present disclosure will be exemplified. However, the present disclosure is not limited to each of the following exemplary example embodiments, and various modifications may be made within the scope described in the claims. For example, example embodiments obtained by appropriately combining techniques (some or all of objects or methods) used in each of the following exemplary example embodiments may fall within the scope of the present disclosure. Example embodiments obtained by appropriately omitting some of the techniques adopted in each of the following exemplary example embodiments may fall within the scope of the present disclosure. Effects mentioned in each of the following exemplary example embodiments are examples of effects expected in the exemplary example embodiment, and do not define extension of the present disclosure. That is, example embodiments that do not exert the effects mentioned in each of the following exemplary example embodiments may also fall within the scope of the present disclosure.

### First Exemplary Example Embodiment

A first exemplary example embodiment that is an example embodiment of the present disclosure will be described in detail with reference to the drawings. The present exemplary example embodiment is a basic form of each of the exemplary example embodiments described later. An application range of each technique adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Furthermore, each technique illustrated in the drawings referred to for describing the present exemplary example embodiment can also be adopted in another exemplary example embodiment included in the present disclosure within a range in which no particular technical problem occurs.

### Configuration of Information processing apparatus

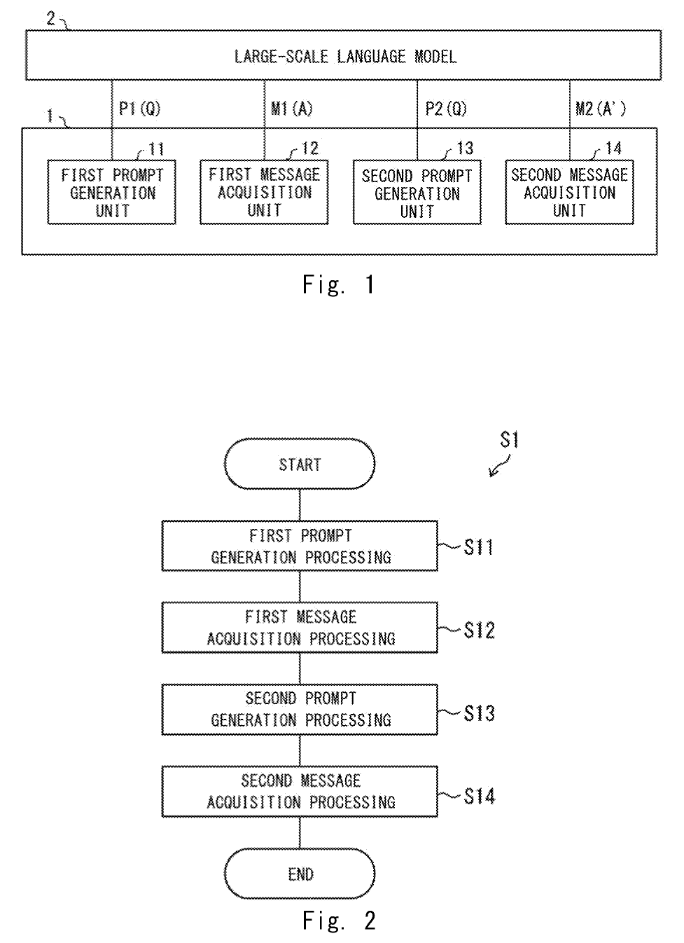

A configuration of an information processing apparatus 1 will be described with reference to FIG. 1. FIG. 1 is a block diagram illustrating a configuration of the information processing apparatus 1.

As illustrated in FIG. 1, the information processing apparatus 1 includes a first prompt generation unit 11, a first message acquisition unit 12, a second prompt generation unit 13, and a second message acquisition unit 14.

The first prompt generation unit 11 is a means for generating a first prompt P1 for requesting to answer a question Q and providing the generated first prompt P1 to a large-scale language model 2.

The first message acquisition unit 12 is a means for acquiring a first message M1 representing an answer A to the question Q from the large-scale language model 2. Here, the first message M1 is a message generated by the large-scale language model 2 as a response to the first prompt P1.

The second prompt generation unit 13 is a means for generating a second prompt P2 for requesting to re-answer the question Q using a reasonable inference method and providing the generated second prompt P2 to the large-scale language model 2.

Here, the inference method being reasonable means that inference processing of deriving an answer from the question Q according to the inference method is inference processing following a logically correct line of reasoning. Various expressions are conceivable as expressions to be included in the second prompt P2 in order to instruct the large-scale language model 2 to use a reasonable inference method. For example, it may be an abstract expression (an expression that does not explicitly include the definition of “reasonable”) such as “using a reasonable inference method” (please answer the question Q), or may be a specific expression (an expression that explicitly includes the definition of “reasonable”) such as (please answer the question Q) “in such a way that inference processing for obtaining an answer is inference processing following a logically correct line of reasoning”. Alternatively, it may be an expression instructing the large-scale language model 2 to use a reasonable inference method after explicitly referring to the past inference performed in the processing of generating the first message M1, such as (please answer the question Q) “please verify whether the inference processing of deriving the answer A from the question Q is inference processing following a logically correct line of reasoning. In a case where this inference processing is not inference processing following a logically correct line of reasoning, correct the inference method in such a way that the inference processing of deriving the answer from the question Q becomes inference processing following a logically correct line of reasoning, and use the inference method after the correction”.

The second message acquisition unit 14 is a means for acquiring a second message M2 representing a re-answer A' to the question Q from the large-scale language model 2. Here, the second message M2 is a message generated by the large-scale language model 2 as a response to the second message M2.

According to the information processing apparatus 1, it is possible to cause the large-scale language model 2 including an experience of inference for deriving the answer A to the question Q to perform inference for deriving the re-answer A' to the question Q using a reasonable inference method. At this time, the large-scale language model 2 can select a reasonable inference method as an inference method for deriving the re-answer A' from the question Q based on the experience of inference for deriving the answer A to the question Q (e.g., can correct the inference method for deriving the answer from the question Q with reference to inference processing of deriving the answer A from the question Q). Therefore, it is possible to obtain a re-answer A' that is more reliable than the answer A.

### Flow of Information Processing Method

A flow of an information processing method S1 will be described with reference to FIG. 2. FIG. 2 is a flowchart illustrating the flow of the information processing method S1.

As illustrated in FIG. 2, the information processing method S1 includes first prompt generation processing S11, first message acquisition processing S12, second prompt generation processing S13, and second message acquisition processing S14. The processing subject of this processing is, for example, at least one processor.

The first prompt generation processing S11 is processing for generating a first prompt P1 for requesting to answer a question Q and providing the generated first prompt P to the large-scale language model 2.

The first message acquisition processing S12 is processing of acquiring a first message M1 representing an answer A to the question Q from the large-scale language model 2. Here, the first message M1 is a message generated by the large-scale language model 2 as a response to the first prompt P1.

The second prompt generation processing S13 is processing of generating a second prompt P2 for requesting to re-answer the question Q using a reasonable inference method and providing the generated second prompt P2 to the large-scale language model 2.

Here, the inference method being reasonable means that inference processing of deriving an answer from the question Q according to the inference method is inference processing following a logically correct line of reasoning. Various expressions are conceivable as expressions to be included in the second prompt P2 in order to instruct the large-scale language model 2 to use a reasonable inference method. For example, it may be an abstract expression (an expression that does not explicitly include the definition of “reasonable”) such as “using a reasonable inference method” (please answer the question Q), or may be a specific expression (an expression that explicitly includes the definition of “reasonable”) such as (please answer the question Q) “in such a way that inference processing for obtaining an answer is inference processing following a logically correct line of reasoning”. Alternatively, it may be an expression instructing the large-scale language model 2 to use a reasonable inference method after explicitly referring to the past inference performed in the processing of generating the first message M1, such as (please answer the question Q) “please verify whether the inference processing of deriving the answer A from the question Q is inference processing following a logically correct line of reasoning. In a case where this inference processing is not inference processing following a logically correct line of reasoning, correct the inference method in such a way that the inference processing of deriving the answer from the question Q becomes inference processing following a logically correct line of reasoning, and use the inference method after the correction”.

The second message acquisition processing S14 is processing of acquiring a second message M2 representing a re-answer A' to the question Q from the large-scale language model 2. Here, the second message M2 is a message generated by the large-scale language model 2 as a response to the second message M2.

According to the above configuration, it is possible to cause the large-scale language model 2 including an experience of inference for deriving the answer A to the question Q to perform inference for deriving the re-answer A' to the question Q using a reasonable inference method. At this time, the large-scale language model 2 can select a reasonable inference method as an inference method for deriving the re-answer A' from the question Q based on the experience of inference for deriving the answer A to the question Q (e.g., can correct the inference method for deriving the answer from the question Q with reference to inference processing of deriving the answer A from the question Q). Therefore, it is possible to obtain a re-answer A' that is more reliable than the answer A.

According to the information processing method S1, it is possible to cause the large-scale language model 2 after performing inference of deriving the answer A to the question Q to perform inference of deriving the re-answer A' to the question Q using a reasonable inference method. Therefore, it is possible to obtain a re-answer A' that is more reliable than the answer A.

### Information Processing System

An information processing system including the information processing apparatus 1 and the large-scale language model 2 is also included in the scope of the present disclosure. According to this information processing system, it is possible to obtain a highly reliable answer (re-answer A') to the question Q.

### Second Exemplary Example Embodiment

A second exemplary example embodiment that is an example embodiment of the present disclosure will be described in detail with reference to the drawings. Components including the same functions as the components described in the exemplary example embodiment described above are denoted by the same reference numerals, and descriptions thereof will be omitted as appropriate. An application range of each technique adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information processing apparatus

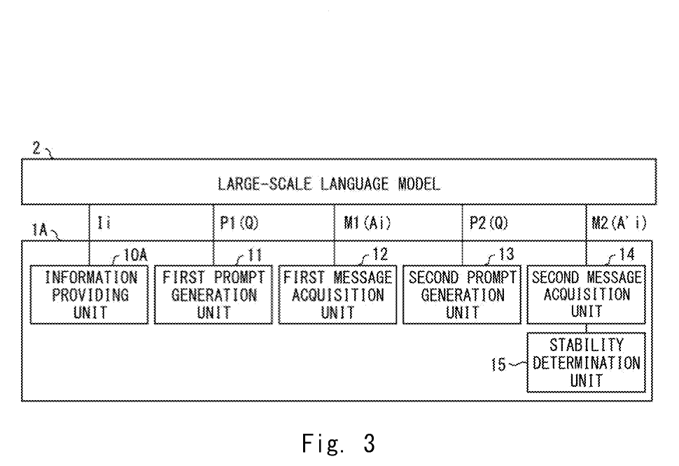

Next, a configuration of the information processing apparatus 1A will be described with reference to FIG. 3. FIG. 3 is a block diagram illustrating a configuration of the information processing apparatus 1A.

As illustrated in FIG. 3, the information processing apparatus 1A includes an information providing unit 10A, a first prompt generation unit 11, a first message acquisition unit 12, a second prompt generation unit 13, a second message acquisition unit 14, and a stability determination unit 15.

The functions of the first prompt generation unit 11, the first message acquisition unit 12, the second prompt generation unit 13, and the second message acquisition unit 14 included in the information processing apparatus 1A are similar to the functions of the first prompt generation unit 11, the first message acquisition unit 12, the second prompt generation unit 13, and the second message acquisition unit 14 included in the information processing apparatus 1 illustrated in FIG. 1.

However, in the information processing apparatus 1A, a session including provision of the first prompt P1 by the first prompt generation unit 11, acquisition of the first message M1 by the first message acquisition unit 12, provision of the second prompt P2 by the second prompt generation unit 13, and acquisition of the second message M2 by the second message acquisition unit 14 is repeated n times. Here, n is any natural number equal to or greater than 2.

The information providing unit 10A is a means for acquiring or generating n pieces of information I1, I2, ..., In different from each other indicating inference processing for deriving an answer to the question Q, and providing each of the acquired or generated n pieces of information I1, I2, ..., In to the large-scale language model 2 prior to each of n sessions. That is, the information providing unit 10A provides the first information I1 to the large-scale language model 2 prior to the first session, provides the second information I2 to the large-scale language model 2 prior to the second session, ..., and provides the n-th information In to the large-scale language model 2 prior to the n-th session.

As a result, the re-answer A'i represented by the second message M2 acquired by the second message acquisition unit 14 in the i-th (i is a natural number of 1 or more and n or less) session becomes an answer based on the information Ii provided by the information providing unit 10A prior to the session, that is, a reasonable answer with reference to the inference processing represented by the information Ii. As a result, there occurs a variety in the re-answers A'1, A'2, ..., and A'n represented by each of the n second messages M2 acquired by the second message acquisition unit 14 in each of the n sessions.

The stability determination unit 15 is a means for determining stability of inference for deriving a re-answer A'i to the question Q from variations in the re-answers A'1, A'2, ..., and A'n indicated by each of the n second messages M2 acquired by the second message acquisition unit 14. The stability determination unit 15 selects, for example, a correct re-answer A'k (k is any natural number of 1 or more and n or less) from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

As an example, assuming that n = 6, in a case where the re-answer A'1 = dog, the re-answer A'2 = cat, the re-answer A'3 = cat, the re-answer A'4 = monkey, the re-answer A'5 = cat, and the re-answer A'6 = cat, the stability determination unit 15 selects a correct re-answer “cat” by majority decision, compares a ratio 4/6 of the re-answers A'2, A'3, A'5, and A'6 that matches the correct re-answer “cat” among the re-answers A'1, A'2, ..., and A'6 with a threshold value 1/2, and determines that the stability of inference for deriving the re-answer A'i to the question Q is high.

According to the information processing apparatus 1A, a re-answer A'k more reliable than the re-answer A' obtained by the information processing apparatus 1 can be obtained. Furthermore, the stability of inference for deriving the re-answer A'i to the question Q can be determined.

### Flow of Information Processing Method

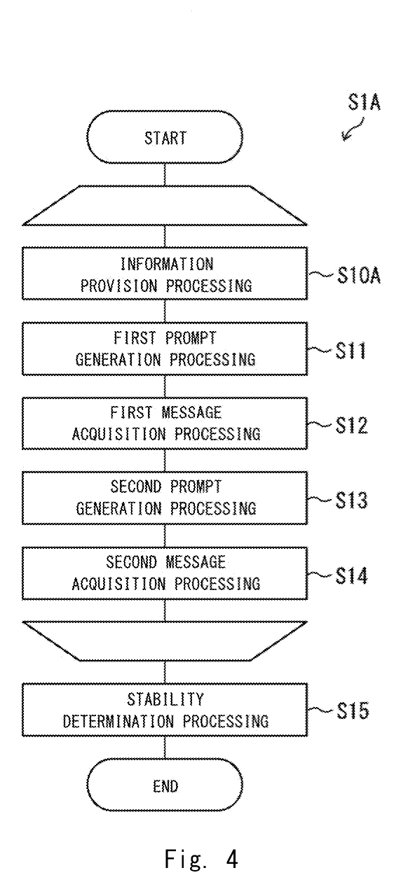

A flow of an information processing method S1A will be described with reference to FIG. 4. FIG. 4 is a flowchart illustrating a flow of the information processing method S1A.

As illustrated in FIG. 4, the information processing method S1A includes information provision processing S10A, first prompt generation processing S11, first message acquisition processing S12, second prompt generation processing S13, second message acquisition processing S14, and stability determination processing S15. The processing subject of this processing is, for example, at least one processor.

The contents of the first prompt generation processing S11, the first message acquisition processing S12, the second prompt generation processing S13, and the second message acquisition processing S14 included in the information processing method S1A are similar to the contents of the first prompt generation processing S11, the first message acquisition processing S12, the second prompt generation processing S13, and the second message acquisition processing S14 included in the information processing method S1 illustrated in FIG. 2.

However, in the information processing method S1A, a session including provision of the first prompt P1 by the first prompt generation processing S11, acquisition of the first message M1 by the first message acquisition processing S12, provision of the second prompt P2 by the second prompt generation processing S13, and acquisition of the second message M2 by the second message acquisition processing S14 is repeated n times. Here, n is any natural number equal to or greater than 2.

The information provision processing S10A is processing of acquiring or generating n pieces of information I1, I2, ..., In different from each other indicating inference processing for deriving an answer to the question Q, and providing each of the acquired or generated n pieces of information I1, I2, ..., In to the large-scale language model 2 prior to each of n sessions. That is, the first information I1 is provided to the large-scale language model 2 prior to the first session in the first information provision processing S10A, the second information I2 is provided to the large-scale language model 2 prior to the second session in the second information provision processing S10A, ..., and the n-th information In is provided to the large-scale language model 2 prior to the n-th session in the n-th information provision processing S10A.

As a result, the re-answer A'i represented by the second message M2 acquired by the second message acquisition processing S14 in the i-th (i is a natural number of 1 or more and n or less) session becomes an answer based on the information Ii provided in the information provision processing S10A prior to the session, that is, a reasonable answer with reference to the inference processing represented by the information Ii. As a result, there occurs a variety in the re-answers A'1, A'2, ..., and A'n represented by each of the n second messages M2 acquired in the second message acquisition processing S14 in each of the n sessions.

The stability determination processing S15 is processing of determining stability of inference for deriving a re-answer A'i to the question Q from variations in the re-answers A'1, A'2, ..., and A'n indicated by each of the n second messages M2 acquired in the second message acquisition processing S14. In the stability determination processing S15, for example, a correct re-answer A'k (k is any natural number of 1 or more and n or less) is selected from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

According to the information processing method S1A, a re-answer A'k more reliable than the re-answer A' obtained by the information processing method S1 can be obtained. Furthermore, the stability of inference for deriving the re-answer A'i to the question Q can be determined.

### Information Processing System

An information processing system including the information processing apparatus 1A and the large-scale language model 2 is also included in the scope of the present disclosure. According to this information processing system, the stability of inference for deriving an answer to the question Q can be determined.

### Third Exemplary Example Embodiment

A third exemplary example embodiment that is an example of the example embodiment of the present disclosure will be described in detail with reference to the drawings. Components including the same functions as the components described in the exemplary example embodiment described above are denoted by the same reference numerals, and descriptions thereof will be omitted as appropriate. An application range of each technique adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information processing apparatus

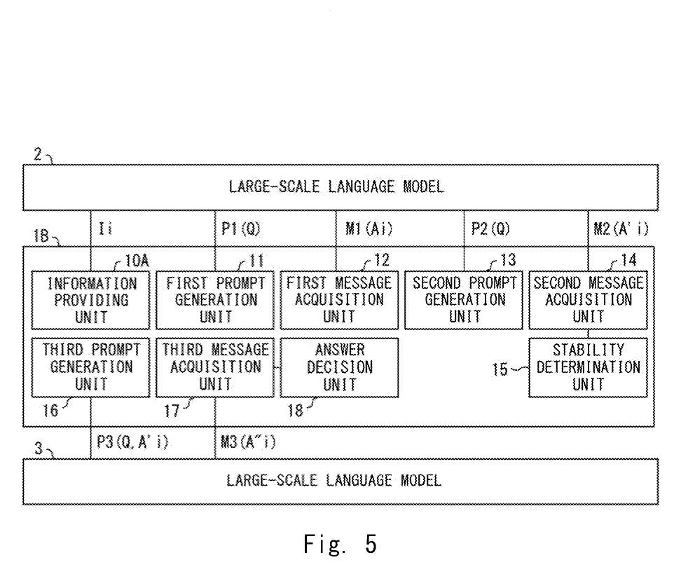

A configuration of an information processing apparatus 1B will be described with reference to FIG. 5. FIG. 5 is a block diagram illustrating a configuration of the information processing apparatus 1B.

As illustrated in FIG. 5, the information processing apparatus 1B includes an information providing unit 10A, a first prompt generation unit 11, a first message acquisition unit 12, a second prompt generation unit 13, a second message acquisition unit 14, a stability determination unit 15, a third prompt generation unit 16, a third message acquisition unit 17, and an answer decision unit 18.

The information processing apparatus 1B is obtained by adding the third prompt generation unit 16, the third message acquisition unit 17, and the answer decision unit 18 to the information processing apparatus 1A illustrated in FIG. 3. The functions of the information providing unit 10A, the first prompt generation unit 11, the first message acquisition unit 12, the second prompt generation unit 13, the second message acquisition unit 14, and the stability determination unit 15 included in the information processing apparatus 1B are similar to the functions of the information providing unit 10A, the first prompt generation unit 11, the first message acquisition unit 12, the second prompt generation unit 13, the second message acquisition unit 14, and the stability determination unit 15 included in the information processing apparatus 1A illustrated in FIG. 3, and thus, description thereof is omitted herein.

The third prompt generation unit 16 is a means for providing, to the large-scale language model 2 or the large-scale language model 3, the third prompt P3 for requesting to answer the question Q using a reasonable inference method in a case where the stability determination unit 15 determines that the inference stability is low. Here, the large-scale language model 3 is a large-scale language model different from the large-scale language model 2. FIG. 5 illustrates a case where the third prompt P3 is provided to the large-scale language model 3.

The third message acquisition unit 17 is a means for acquiring, from the large-scale language model 2 or the large-scale language model 3, the third message M3 representing the answer A" to the question Q in a case where the stability determination unit 15 determines that the inference stability is low. Here, the third message M3 is a message generated by the large-scale language model 2 or the large-scale language model 3 as a response to the third prompt P3. FIG. 5 illustrates a case where the third message M3 is acquired from the large-scale language model 3.

In the information processing apparatus 1B, (1) a session including the provision of the first prompt P1 by the first prompt generation unit 11, the acquisition of the first message M1 by the first message acquisition unit 12, the provision of the second prompt P2 by the second prompt generation unit 13, and the acquisition of the second message M2 by the second message acquisition unit 14 is repeated n times (first phase), (2) determination by the stability determination unit 15 is performed, and (3) in a case where the determination result by the stability determination unit 15 is unstable, a session B including the provision of the third prompt P3 by the third prompt generation unit 16 and the acquisition of the third message M3 by the third message acquisition unit 17 is repeated n times (second phase).

The third prompt P3 provided by the third prompt generation unit 16 in the i-th session of the second phase includes a question Q and a re-answer A'i represented by the second message M2 acquired by the second message acquisition unit 14 in the i-th session of the first phase. Therefore, the answer A"i represented by the third message M3 acquired by the third message acquisition unit 17 in the i-th session of the second phase becomes an answer according to the re-answer A'i represented by the second message M2 acquired by the second message acquisition unit 14 in the i-th session of the first phase. As a result, there occurs a variety in the answers A"1, A"2, ..., and A"n represented by each of the n third messages M3 acquired by the third message acquisition unit 17 in each of the n sessions of the second phase.

The answer decision unit 18 is a means for deciding a final answer A" to the question Q based on the answers A"1, A"2, ..., A"n represented by each of the n third messages M3 acquired by the third message acquisition unit 17. The answer decision means 18 decides, for example, a final answer A" from the re-answers A"1, A"2, ..., A"n by majority decision.

According to the information processing apparatus 1B, in a case where the stability of inference for deriving the re-answer A'i to the question Q is low, a final answer A" more reliable than the re-answer A'k obtained by the information processing apparatus 1A can be obtained.

### Flow of Information Processing Method

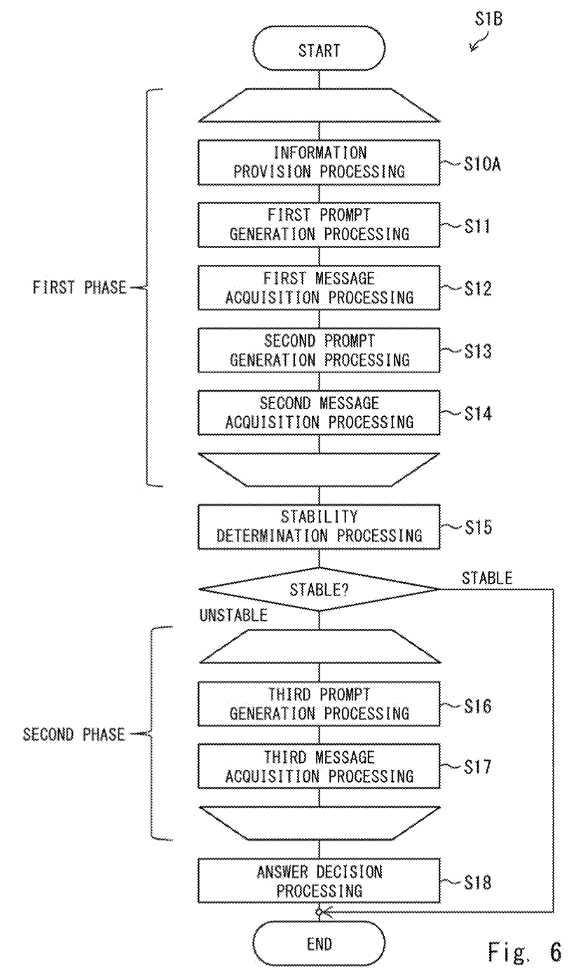

A flow of an information processing method S1B will be described with reference to FIG. 6. FIG. 6 is a flowchart illustrating the flow of the information processing method S1B.

As illustrated in FIG. 6, the information processing method S1B includes information provision processing S10A, first prompt generation processing S11, first message acquisition processing S12, second prompt generation processing S13, second message acquisition processing S14, stability determination processing S15, third prompt generation processing S16, third message acquisition processing S17, and answer decision processing S18. The processing subject of this processing is, for example, at least one processor.

The information processing method S1B is obtained by adding third prompt generation processing S16, third message acquisition processing S17, and answer decision processing S18 to the information processing method S1A illustrated in FIG. 4. The contents of the information provision processing S10A, the first prompt generation processing S11, the first message acquisition processing S12, the second prompt generation processing S13, the second message acquisition processing S14, and the stability determination processing S15 included in the information processing method S1B are similar to the contents of the information provision processing S10A, the first prompt generation processing S11, the first message acquisition processing S12, the second prompt generation processing S13, the second message acquisition processing S14, and the stability determination processing S15 included in the information processing method S1A illustrated in FIG. 3, and thus the description thereof will be omitted herein.

The third prompt generation processing S16 is processing of providing, to the large-scale language model 2 or the large-scale language model 3, the third prompt P3 for requesting to answer the question Q using a reasonable inference method in a case where the stability determination processing S15 determines that the inference stability is low.

The third message acquisition processing S17 is processing of acquiring, from the large-scale language model 2 or the large-scale language model 3, the third message M3 representing the answer A" to the question Q in a case where the stability determination processing S15 determines that the inference stability is low. Here, the third message M3 is a message generated by the large-scale language model 2 or the large-scale language model 3 as a response to the third prompt P3.

In the information processing method S1B, (1) a session including the provision of the first prompt P1 by the first prompt generation processing S11, the acquisition of the first message M1 by the first message acquisition processing S12, the provision of the second prompt P2 by the second prompt generation processing S13, and the acquisition of the second message M2 by the second message acquisition processing S14 is repeated n times (first phase), (2) determination by the stability determination processing S15 is performed, and (3) in a case where the determination result by the stability determination processing S15 is unstable, a session including the provision of the third prompt P3 by the third prompt generation processing S16 and the acquisition of the third message M3 by the third message acquisition processing S17 is repeated n times (second phase).

The third prompt P3 provided by the third prompt generation processing S16 in the i-th session of the second phase includes a question Q and a re-answer A'i represented by the second message M2 acquired by the second message acquisition processing S14 in the i-th session of the first phase. Therefore, the answer A"i represented by the third message M3 acquired by the third message acquisition processing S17 in the i-th session of the second phase becomes an answer according to the re-answer A'i represented by the second message M2 acquired by the second message acquisition unit 14 in the i-th session of the first phase. As a result, there occurs a variety in the answers A"1, A"2, ..., and A"n represented by each of the n third messages M3 acquired by the third message acquisition processing S17 in each of the n sessions of the second phase.

The answer decision processing S18 is processing of deciding a final answer A" to the question Q based on the answers A"1, A"2, ..., A"n represented by each of the n third messages M3 acquired by the third message acquisition processing S17. In the answer decision processing S18, for example, a final answer A" is decided from the re-answers A"1, A"2, ..., A"n by majority decision.

According to the information processing method S1B, in a case where the stability of inference for deriving the re-answer A'i to the question Q is low, a final answer A" more reliable than the re-answer A'k obtained by the information processing method S1A can be obtained.

### Information Processing System

An information processing system including the information processing apparatus 1B and the large-scale language model 2 or an information processing system including the information processing apparatus 1B, the large-scale language model 2, and the large-scale language model 3 is also included in the scope of the present disclosure. According to these information processing systems, a highly reliable answer can be obtained for the question Q.

### Fourth Exemplary Example Embodiment

A fourth exemplary example embodiment that is an example of the example embodiments of the present disclosure will be described in detail with reference to the drawings. Components including the same functions as the components described in the exemplary example embodiment described above are denoted by the same reference numerals, and descriptions thereof will be omitted as appropriate. An application range of each technique adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information processing apparatus

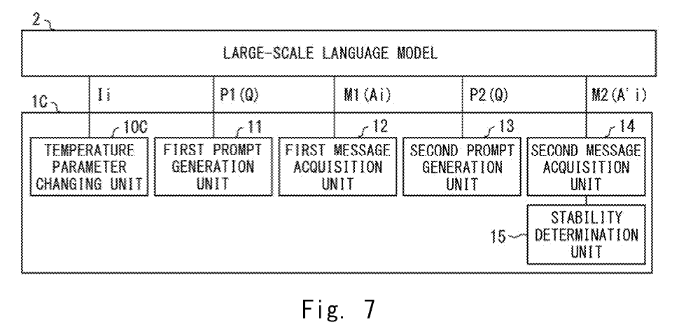

A configuration of an information processing apparatus 1C will be described with reference to FIG. 7. FIG. 7 is a block diagram illustrating the configuration of the information processing apparatus 1C.

As illustrated in FIG. 7, the information processing apparatus 1C includes a temperature parameter changing unit 10C, a first prompt generation unit 11, a first message acquisition unit 12, a second prompt generation unit 13, a second message acquisition unit 14, and a stability determination unit 15.

The functions of the first prompt generation unit 11, the first message acquisition unit 12, the second prompt generation unit 13, and the second message acquisition unit 14 included in the information processing apparatus 1C are similar to the functions of the first prompt generation unit 11, the first message acquisition unit 12, the second prompt generation unit 13, and the second message acquisition unit 14 included in the information processing apparatus 1 illustrated in FIG. 1.

However, in the information processing apparatus 1C, a session including provision of the first prompt P1 by the first prompt generation unit 11, acquisition of the first message M1 by the first message acquisition unit 12, provision of the second prompt P2 by the second prompt generation unit 13, and acquisition of the second message M2 by the second message acquisition unit 14 is repeated n times. Here, n is any natural number equal to or greater than 2.

The temperature parameter changing unit 10C is a means for changing the temperature parameter of the large-scale language model 2 prior to each of the n sessions. That is, the temperature parameter changing unit 10C sets the temperature parameter of the large-scale language model 2 to T1 prior to the first session, changes the temperature parameter of the large-scale language model 2 to T2 prior to the second session, ..., and changes the temperature parameter of the large-scale language model 2 to Tn prior to the n-th session. However, if the temperature parameter is other than 0.0, T1, T2, ..., and Tn may be the same.

As a result, the re-answer A'i represented by the second message M2 acquired by the second message acquisition unit 14 in the i-th session (i is a natural number of 1 or more and n or less) becomes an answer under the temperature parameter Ti provided by the temperature parameter changing unit 10C prior to the session. As a result, there occurs a variety in the re-answers A'1, A'2, ..., and A'n represented by each of the n second messages M2 acquired by the second message acquisition unit 14.

The stability determination unit 15 is a means for determining stability of inference for deriving a re-answer A'i to the question Q from variations in the re-answers A'1, A'2, ..., and A'n indicated by each of the n second messages M2 acquired by the second message acquisition unit 14. The stability determination unit 15 selects, for example, a correct re-answer A'k (k is any natural number of 1 or more and n or less) from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

According to the information processing apparatus 1C, a re-answer A'k more reliable than the re-answer A' obtained by the information processing apparatus 1 can be obtained. Furthermore, the stability of inference for deriving the re-answer A'i to the question Q can be determined.

### Flow of Information Processing Method

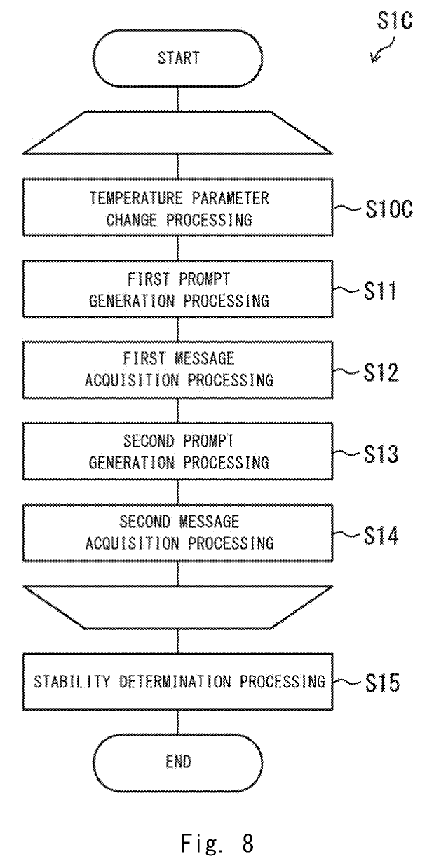

The flow of an information processing method S1C will be described with reference to FIG. 8. FIG. 8 is a flowchart illustrating a flow of the information processing method S1C.

As illustrated in FIG. 8, the information processing method S1C includes temperature parameter change processing S10C, first prompt generation processing S11, first message acquisition processing S12, second prompt generation processing S13, second message acquisition processing S14, and stability determination processing S15. The processing subject of this processing is, for example, at least one processor.

The contents of the first prompt generation processing S11, the first message acquisition processing S12, the second prompt generation processing S13, and the second message acquisition processing S14 included in the information processing method S1C are similar to the contents of the first prompt generation processing S11, the first message acquisition processing S12, the second prompt generation processing S13, and the second message acquisition processing S14 included in the information processing method S1 illustrated in FIG. 2.

However, in the information processing method S1C, a session including provision of the first prompt P1 by the first prompt generation processing S11, acquisition of the first message M1 by the first message acquisition processing S12, provision of the second prompt P2 by the second prompt generation processing S13, and acquisition of the second message M2 by the second message acquisition processing S14 is repeated n times. Here, n is any natural number equal to or greater than 2.

The temperature parameter change processing S10C is processing of changing the temperature parameter of the large-scale language model 2 prior to each of the n sessions. That is, the temperature parameter of the large-scale language model 2 is set to T1 prior to the first session in the first temperature parameter change processing S10C, the temperature parameter of the large-scale language model 2 is changed to T2 prior to the second session in the second temperature parameter change processing S10C, ..., and the temperature parameter of the large-scale language model 2 is changed to Tn prior to the n-th session in the n-th temperature parameter change processing S10C. However, if the temperature parameter is other than 0.0, T1, T2, ..., and Tn may be the same.

As a result, the re-answer A'i represented by the second message M2 acquired by the second message acquisition processing S14 in the i-th session (i is a natural number of 1 or more and n or less) becomes an answer under the temperature parameter Ti provided by the temperature parameter change processing S10C prior to the session. As a result, there occurs a variety in the re-answers A'1, A'2, ..., and A'n represented by each of the n second messages M2 acquired by the second message acquisition processing S14.

The stability determination processing S15 is processing of determining stability of inference for deriving a re-answer A'i to the question Q from variations in the re-answers A'1, A'2, ..., and A'n indicated by each of the n second messages M2 acquired in the second message acquisition processing S14. In the stability determination processing S15, for example, a correct re-answer A'k (k is any natural number of 1 or more and n or less) is selected from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

According to the information processing method S1C, a re-answer A'k more reliable than the re-answer A' obtained by the information processing method S1 can be obtained. Furthermore, the stability of inference for deriving the re-answer A'i to the question Q can be determined.

### Information Processing System

An information processing system including the information processing apparatus 1C and the large-scale language model 2 is also included in the scope of the present disclosure. According to this information processing system, the stability of inference for deriving an answer to the question Q can be determined.

### Fifth Exemplary Example Embodiment

A fifth exemplary example embodiment that is an example of the example embodiments of the present disclosure will be described in detail with reference to the drawings. Components including the same functions as the components described in the exemplary example embodiment described above are denoted by the same reference numerals, and descriptions thereof will be omitted as appropriate. An application range of each technique adopted in the present exemplary example embodiment is not limited to the present exemplary example embodiment. That is, each technique adopted in the present exemplary example embodiment can also be adopted in another example embodiment included in the present disclosure within a range in which no particular technical problem occurs. Each technique illustrated in each of the drawings referred to for describing the present exemplary example embodiment can be adopted in the other exemplary example embodiments included in the present disclosure within a range in which no particular technical problem occurs.

### Configuration of Information processing apparatus

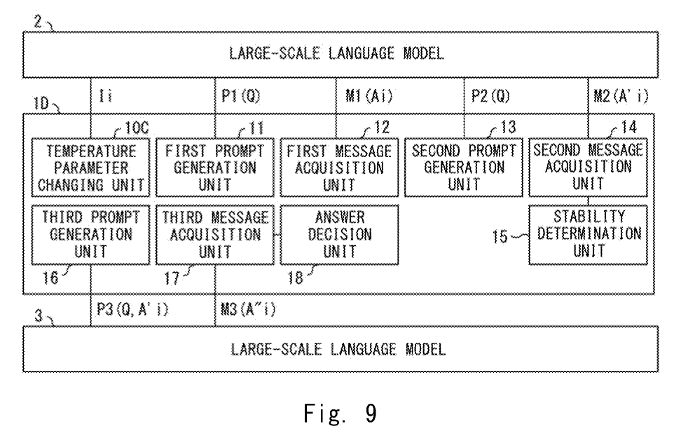

A configuration of an information processing apparatus 1D will be described with reference to FIG. 9. FIG. 9 is a block diagram illustrating the configuration of the information processing apparatus 1D.

As illustrated in FIG. 9, the information processing apparatus 1D includes a temperature parameter changing unit 10C, a first prompt generation unit 11, a first message acquisition unit 12, a second prompt generation unit 13, a second message acquisition unit 14, a stability determination unit 15, a third prompt generation unit 16, a third message acquisition unit 17, and an answer decision unit 18.

The information processing apparatus 1D is obtained by adding the third prompt generation unit 16, the third message acquisition unit 17, and the answer decision unit 18 to the information processing apparatus 1C illustrated in FIG. 7. The functions of the temperature parameter changing unit 10C, the first prompt generation unit 11, the first message acquisition unit 12, the second prompt generation unit 13, the second message acquisition unit 14, and the stability determination unit 15 included in the information processing apparatus 1D are similar to the functions of the temperature parameter changing unit 10C, the first prompt generation unit 11, the first message acquisition unit 12, the second prompt generation unit 13, the second message acquisition unit 14, and the stability determination unit 15 included in the information processing apparatus 1C illustrated in FIG. 7, and thus, description thereof is omitted herein.

The third prompt generation unit 16 is a means for providing, to the large-scale language model 2 or the large-scale language model 3, the third prompt P3 for requesting to answer the question Q using a reasonable inference method in a case where the stability determination unit 15 determines that the inference stability is low. Here, the large-scale language model 3 is a large-scale language model different from the large-scale language model 2. FIG. 9 illustrates a case where the third prompt P3 is provided to the large-scale language model 3.

The third message acquisition unit 17 is a means for acquiring, from the large-scale language model 2 or the large-scale language model 3, the third message M3 representing the answer A" to the question Q in a case where the stability determination unit 15 determines that the inference stability is low. Here, the third message M3 is a message generated by the large-scale language model 2 or the large-scale language model 3 as a response to the third prompt P3. FIG. 9 illustrates a case where the third message M3 is acquired from the large-scale language model 3.

In the information processing apparatus 1D, (1) a session including the provision of the first prompt P1 by the first prompt generation unit 11, the acquisition of the first message M1 by the first message acquisition unit 12, the provision of the second prompt P2 by the second prompt generation unit 13, and the acquisition of the second message M2 by the second message acquisition unit 14 is repeated n times (first phase), (2) determination by the stability determination unit 15 is performed, and (3) in a case where the determination result by the stability determination unit 15 is unstable, a session B including the provision of the third prompt P3 by the third prompt generation unit 16 and the acquisition of the third message M3 by the third message acquisition unit 17 is repeated n times (second phase).

The third prompt P3 provided by the third prompt generation unit 16 in the i-th session of the second phase includes a question Q and a re-answer A'i represented by the second message M2 acquired by the second message acquisition unit 14 in the i-th session of the first phase. Therefore, the answer A"i represented by the third message M3 acquired by the third message acquisition unit 17 in the i-th session of the second phase becomes an answer according to the re-answer A'i represented by the second message M2 acquired by the second message acquisition unit 14 in the i-th session of the first phase. As a result, there occurs a variety in the answers A"1, A"2, ..., and A"n represented by each of the n third messages M3 acquired by the third message acquisition unit 17 in each of the n sessions of the second phase.

The answer decision unit 18 is a means for deciding a final answer A" to the question Q based on the answers A"1, A"2, ..., A"n represented by each of the n third messages M3 acquired by the third message acquisition unit 17. The answer decision unit 18 decides, for example, a final answer A" from the re-answers A"1, A"2, ..., A"n by majority decision.

According to the information processing apparatus 1D, in a case where the stability of inference for deriving the re-answer A'i to the question Q is low, a final answer A" more reliable than the re-answer A'k obtained by the information processing apparatus 1C can be obtained.

### Flow of Information Processing Method

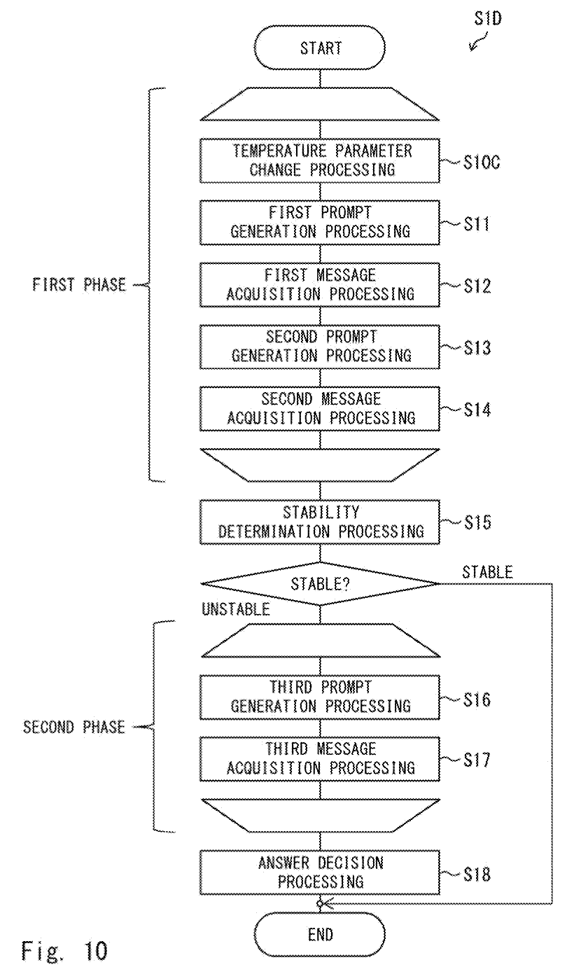

The flow of an information processing method S1D will be described with reference to FIG. 10. FIG. 10 is a flowchart illustrating a flow of the information processing method S1D.

As illustrated in FIG. 10, the information processing method S1D includes temperature parameter change processing S10C, first prompt generation processing S11, first message acquisition processing S12, second prompt generation processing S13, second message acquisition processing S14, stability determination processing S15, third prompt generation processing S16, third message acquisition processing S17, and answer decision processing S18. The processing subject of this processing is, for example, at least one processor.

The information processing method S1D is obtained by adding third prompt generation processing S16, third message acquisition processing S17, and answer decision processing S18 to the information processing method S1C illustrated in FIG. 8. The contents of the temperature parameter change processing S10C, the first prompt generation processing S11, the first message acquisition processing S12, the second prompt generation processing S13, the second message acquisition processing S14, and the stability determination processing S15 included in the information processing method S1D are similar to the contents of the temperature parameter change processing S10C, the first prompt generation processing S11, the first message acquisition processing S12, the second prompt generation processing S13, the second message acquisition processing S14, and the stability determination processing S15 included in the information processing method S1C illustrated in FIG. 7, and thus the description thereof will be omitted herein.

The third prompt generation processing S16 is processing of providing, to the large-scale language model 2 or the large-scale language model 3 different from the large-scale language model 2, the third prompt P3 for requesting to answer the question Q using a reasonable inference method in a case where the stability determination processing S15 determines that the inference stability is low.

The third message acquisition processing S17 is processing of acquiring, from the large-scale language model 2 or the large-scale language model 3, the third message M3 representing the answer A" to the question Q in a case where the stability determination processing S15 determines that the inference stability is low. Here, the third message M3 is a message generated by the large-scale language model 2 or the large-scale language model 3 as a response to the third prompt P3.

In the information processing method S1D, (1) a session including the provision of the first prompt P1 by the first prompt generation processing S11, the acquisition of the first message M1 by the first message acquisition processing S12, the provision of the second prompt P2 by the second prompt generation processing S13, and the acquisition of the second message M2 by the second message acquisition processing S14 is repeated n times (first phase), (2) determination by the stability determination processing S15 is performed, and (3) in a case where the determination result by the stability determination processing S15 is unstable, a session including the provision of the third prompt P3 by the third prompt generation processing S16 and the acquisition of the third message M3 by the third message acquisition processing S17 is repeated n times (second phase).

The third prompt P3 provided by the third prompt generation processing S16 in the i-th session of the second phase includes a question Q and a re-answer A'i represented by the second message M2 acquired by the second message acquisition processing S14 in the i-th session of the first phase. Therefore, the answer A"i represented by the third message M3 acquired by the third message acquisition processing S17 in the i-th session of the second phase becomes an answer according to the re-answer A'i represented by the second message M2 acquired by the second message acquisition unit 14 in the i-th session of the first phase. As a result, there occurs a variety in the answers A"1, A"2, ..., and A"n represented by each of the n third messages M3 acquired by the third message acquisition processing S17 in each of the n sessions of the second phase.

The answer decision processing S18 is processing of deciding a final answer A" to the question Q based on the answers A"1, A"2, ..., A"n represented by each of the n third messages M3 acquired by the third message acquisition processing S17. In the answer decision processing S18, for example, a final answer A" is decided from the re-answers A"1, A"2, ..., A"n by majority decision.

According to the information processing method S1D, it is possible to obtain a final answer A" with higher reliability than the re-answer A'k obtained by the information processing method S1C in a case where the stability of inference for deriving the re-answer A'i to the question Q is low.

### Information Processing System

An information processing system including the information processing apparatus 1D and the large-scale language model 2 or an information processing system including the information processing apparatus 1D, the large-scale language model 2, and the large-scale language model 3 is also included in the scope of the present disclosure. According to these information processing systems, a highly reliable answer can be obtained for the question Q.

### First Exemplary Operation Example

An exemplary operation example of the information processing apparatus 1B illustrated in FIG. 5 will be described again with reference to FIG. 6. In the present operation example, a question asking the TNM stage of lung cancer after giving an interpretation report is considered as the question Q. The interpretation report expresses, in natural language, findings obtained by a doctor or the like by interpreting an X-ray image, and is, for example, text data such as “A lobulated irregular mass lesion of about 3 cm is observed on the peripheral side of the lower lobe of the left lung. Although the main component is solid, ...”.

The information processing apparatus 1B acquires l Chain of Thoughts (CoT) created by a doctor or the like or output by AI. Each CoT expresses, in natural language, inference processing of deriving an answer to the question Q (deciding the TNM stage from the interpretation report), and is, for example, text data such as “The size of the tumor is equal to or greater than 2 cm and equal to or less than 3 cm. Therefore, the evaluation of the primary tumor (T) is T1c. The interpretation report does not describe information regarding the regional lymph nodes. Therefore, the evaluation of the regional lymph nodes (N) is N0. The interpretation report does not describe information related to distant metastasis. Therefore, the evaluation of the distant metastasis (M) is M0. From the above, the TNM stage is T1cN0M0”.

Next, the information processing apparatus 1B selects m CoTs from the acquired l CoTs. For example, each of the interpretation report included in the question Q and the l CoTs is embedded in the vector space, and m CoTs are selected in order from one close to the interpretation report in the vector space. Here, m is any natural number satisfying m! ≥ n, and l is any natural number satisfying l ≥ m.

After performing the above preparation, the information processing apparatus 1B repeats the following processing n times in the first phase.

Information provision processing S10A: generate information Ii (few-shot example) by shuffling the selected m CoTs, and provide the generated information Ii to the large-scale language model 2. With this shuffling, the information I1, I2, ..., In provided to the large-scale language model 2 in the first phase become different from each other.

First prompt generation processing S11: generate a first prompt P1 for requesting to answer a question Q together with the interpretation report and provide the generated first prompt P1 to the large-scale language model 2. The first prompt P1 expresses an answer request to the question Q in a natural language, and is, for example, text data such as “Please determine the TNM stage of a patient based on interpretation report”.

First message acquisition processing S12: acquire a first message M1 representing an answer Ai to the question Q from the large-scale language model 2. The first message M1 represents the answer Ai in a natural language, and is, for example, text data such as “The TNM stage for this patient is T2aN0M0”.

Second prompt generation processing S13: generate a second prompt P2 for requesting to re-answer the question Q using a reasonable inference method and provide the generated second prompt P2 to the large-scale language model 2. The second prompt P2 expresses a re-answer request to the question Q in a natural language, and is text data such as “Please review whether the inference is correctly performed according to the classification definition and then perform re-inference”.

Second message acquisition processing S14: acquire a second message M2 representing a re-answer A'i to the question Q from the large-scale language model 2. The second message M2 represents the re-answer A'i in a natural language, and is, for example, text data such as “The TNM stage for this patient is T2bN0M0”.

After the first phase is completed, the information processing apparatus 1B executes stability determination processing S15.

Stability determination processing S15: determine stability of inference for deriving a re-answer A'i to the question Q based on the re-answers A'1, A'2, ..., and A'n indicated by each of the n second messages M2 acquired in the first phase. Specifically, a correct re-answer A'k (k is any natural number of 1 or more and n or less) is selected from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

In a case where it is determined in the stability determination processing S15 that the inference stability is high, the information processing apparatus 1B outputs the re-answer Ak decided by majority decision as a final answer and terminates the series of processing. In a case where it is determined in the stability determination processing S15 that the inference stability is low, the information processing apparatus 1B executes each of the following processing in the second phase.

Third prompt generation processing S16: provide a third prompt P3 for requesting to answer the question Q using a reasonable inference method to the large-scale language model 3. The third prompt P3 expresses an answer request to the question Q including the re-answer Ai in a natural language, and for example, is text data such as “The TNM stage for this patient was determined to be T2bN0M0 based on the interpretation report. Please review if this result is a correct inference result conforming to the classification definition and then perform re-inference”.

Third message acquisition processing S17: acquire a third message M3 representing an answer A"i to the question Q from the large-scale language model 2 or the large-scale language model 3. The third message is a natural language representation of the answer A"i, and is, for example, text data such as “The TNM stage for this patient is T4N1M1A”.

After the second phase is completed, the information processing apparatus 1B executes answer decision processing S18.

Answer decision processing S18: A final answer A" to the question Q is decided based on the answer A"1, A"2, ..., A"n represented by each of the n third messages M3 acquired in the second phase. Specifically, the final answer A" is selected from the re-answer A"1, A"2, ..., A"n by majority decision.

### Second Exemplary Operation Example

An exemplary operation example of the information processing apparatus 1D illustrated in FIG. 9 will be described again with reference to FIG. 10. In the present operation example, similarly to the above-described operation example, a question asking the TNM stage of lung cancer after giving an interpretation report is considered as the question Q.

The information processing apparatus 1D repeats the following processing n times in the first phase.

Temperature parameter change processing S10B: set the temperature parameter of the large-scale language model 2 to Ti.

First prompt generation processing S11: generate a first prompt P1 for requesting to answer a question Q together with the interpretation report and provide the generated first prompt P1 to the large-scale language model 2. The first prompt P1 expresses an answer request to the question Q in a natural language, and is, for example, text data such as “Please determine the TNM stage of a patient based on interpretation report”.

First message acquisition processing S12: acquire a first message M1 representing an answer Ai to the question Q from the large-scale language model 2. The first message M1 represents the answer Ai in a natural language, and is, for example, text data such as “The TNM stage for this patient is T2aN0M0”.

Second prompt generation processing S13: generate a second prompt P2 for requesting to re-answer the question Q using a reasonable inference method and provide the generated second prompt P2 to the large-scale language model 2. The second prompt P2 expresses a re-answer request to the question Q in a natural language, and is text data such as “Please review whether the inference is correctly performed according to the classification definition and then perform re-inference”.

Second message acquisition processing S14: acquire a second message M2 representing a re-answer A'i to the question Q from the large-scale language model 2. The second message M2 represents the re-answer A'i in a natural language, and is, for example, text data such as “The TNM stage for this patient is T2bN0M0”.

After the first phase is completed, the information processing apparatus 1D executes stability determination processing S15.

Stability determination processing S15: determine stability of inference for deriving a re-answer A'i to the question Q based on the re-answers A'1, A'2, ..., and A'n indicated by each of the n second messages M2 acquired in the first phase. Specifically, a correct re-answer A'k (k is any natural number of 1 or more and n or less) is selected from the re-answers A'1, A'2, ..., and A'n by majority decision. Then, it is determined whether the stability of inference for deriving the re-answer A'i to the question Q is high or low depending on whether the ratio of the re-answer matching the correct re-answer A'k among the re-answers A'1, A'2, ..., and A'n is equal to or greater than or less than a predetermined threshold value.

In a case where it is determined in the stability determination processing S15 that the inference stability is high, the information processing apparatus 1D outputs the re-answer Ak decided by majority decision as a final answer and terminates the series of processing. In a case where it is determined in the stability determination processing S15 that the inference stability is low, the information processing apparatus 1D executes each of the following processing in the second phase.

Third prompt generation processing S16: provide a third prompt P3 for requesting to answer the question Q using a reasonable inference method to the large-scale language model 3. The third prompt P3 expresses an answer request to the question Q including the re-answer Ai in a natural language, and for example, is text data such as “The TNM stage for this patient was determined to be T2bN0M0 based on the interpretation report. Please review if this result is a correct inference result conforming to the classification definition and then perform re-inference”.

Third message acquisition processing S17: acquire a third message M3 representing an answer A"i to the question Q from the large-scale language model 2 or the large-scale language model 3. The third message is a natural language representation of the answer A"i, and is, for example, text data such as “The TNM stage for this patient is T4N1M1A”.

After the second phase is completed, the information processing apparatus 1D executes answer decision processing S18.

Answer decision processing S18: A final answer A" to the question Q is decided based on the answer A"1, A"2, ..., A"n represented by each of the n third messages M3 acquired in the second phase. Specifically, the final answer A" is selected from the re-answer A"1, A"2, ..., A"n by majority decision.

### Implementation Example by Software

Some or all of the functions of the information processing apparatuses 1, 1A, 1B, 1C and 1D (hereinafter also referred to as “each of the above-described apparatuses”) may be implemented by hardware such as an integrated circuit (IC chip) or may be implemented by software.

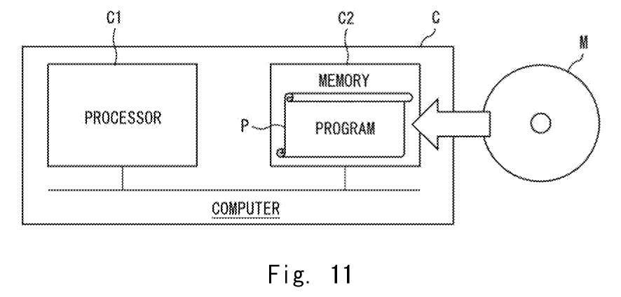

In the latter case, each of the above apparatuses is implemented by, for example, a computer that executes commands of a program, that is software for implementing each function. An example of such a computer (hereinafter referred to as a computer C) is illustrated in FIG. 11. FIG. 11 is a block diagram illustrating a hardware configuration of the computer C that functions as each of the above apparatuses.

The computer C includes at least one processor C1 and at least one memory C2. A program P for causing the computer C to operate as each of the above apparatuses is recorded in the memory C2. In the computer C, by the processor C1 reading the program P from the memory C2 and executing the program P, each function of each of the above apparatuses is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof can be used. As the memory C2, for example, a flash memory, a Hard Disk Drive (HDD), a Solid State Drive (SSD), or a combination thereof can be used.

The computer C may further include a Random Access Memory (RAM) for loading the program P at the time of execution and temporarily storing various types of data. The computer C may further include a communication interface for transmitting and receiving data to and from another apparatus. The computer C may further include an input/output interface for connecting input/output devices such as a keyboard, a mouse, a display, and a printer.

In addition, the program P can be recorded on a non-transitory tangible computer readable medium M readable by the computer C. As such a recording medium M, for example, a tape, a disk, a card, a semiconductor memory, a programmable logic circuit, or the like can be used. The computer C can acquire the program P via such a recording medium M. The program P can be transmitted via a transmission medium. As such a transmission medium, for example, a communication network, a broadcast wave, or the like can be used. The computer C can also acquire the program P via such a transmission medium.

Each of the above functions of each of the above apparatuses may be achieved by a single processor provided in a single computer, may be achieved in cooperation with a plurality of processors provided in a single computer, or may be achieved in cooperation with a plurality of processors provided in each of a plurality of computers. The program for causing each of the above apparatuses to achieve each of the above functions may be stored in a single memory provided in a single computer, may be stored in a distributed manner in a plurality of memories provided in a single computer, or may be stored in a distributed manner in a plurality of memories provided in each of a plurality of computers.

### SUPPLEMENTARY INFORMATION 1

The present disclosure includes the techniques described in the following Supplementary Notes. However, the present disclosure is not limited to the techniques described in the following Supplementary Notes, and various modifications may be made within the scope described in the claims.

### Supplementary Note 1

An information processing apparatus including

a first prompt generation means for generating a first prompt for requesting to answer a question and providing the generated first prompt to a large-scale language model,

a first message acquisition means for acquiring a first message representing an answer to the question from the large-scale language model as a response to the first prompt,

a second prompt generation means for generating a second prompt for requesting to re-answer the question using a reasonable inference method and providing the generated second prompt to the large-scale language model, and

a second message acquisition means for acquiring a second message representing a re-answer to the question from the large-scale language model as a response to the second prompt.

### Supplementary Note 2

The information processing apparatus according to supplementary note 1, further including a stability determination means for determining stability of inference for deriving a re-answer to the question from variation in re-answers represented by each of a plurality of second messages obtained by repeatedly executing a session including provision of a first prompt by the first prompt generation means, acquisition of a first message by the first message acquisition means, provision of a second prompt by the second prompt generation means, and acquisition of a second message by the second message acquisition means.

### Supplementary Note 3

The information processing apparatus according to supplementary note 2, further including an information providing means for providing, to the large-scale language model, each of a plurality of pieces of information different from each other indicating inference processing of deriving an answer to the question prior to each of the plurality of sessions.

### Supplementary Note 4

The information processing apparatus according to supplementary note 2, further including a temperature parameter changing means for changing a value of a temperature parameter of the large-scale language model prior to each of the plurality of sessions.

### Supplementary Note 5

The information processing apparatus according to any one of supplementary notes 2 to 4, further including

a third prompt generation means for generating, in a case where the stability determination means determines that stability is low, for a re-answer represented by each of the plurality of second messages, a third prompt for requesting to answer the question using a reasonable inference method, the third prompt including the question and the re-answer and providing the third prompt to the large-scale language model or another large-scale language model different from the large-scale language model,

a third message acquisition means for acquiring, in a case where the stability determination means determines that stability is low, for a re-answer represented by each of the plurality of second messages, a third message representing an answer to the question from the large-scale language model or the another large-scale language model as a response to the third prompt including the question and the re-answer, and

an answer decision means for deciding a final answer to the question based on an answer represented by each of a plurality of third messages obtained by repeating provision of a third prompt by the third prompt generation means and acquisition of a third message by the third message acquisition means.

### Supplementary Note 6

An information processing method including

first prompt generation processing in which at least one processor generates a first prompt for requesting to answer a question and provides the generated first prompt to a large-scale language model,

first message acquisition processing in which the at least one processor acquires a first message representing an answer to the question from the large-scale language model as a response to the first prompt,

second prompt generation processing in which the at least one processor generates a second prompt for requesting to re-answer the question using a reasonable inference method and provides the generated second prompt to the large-scale language model, and

a second message acquisition processing in which the at least one processor acquires a second message representing a re-answer to the question from the large-scale language model as a response to the second prompt.

### Supplementary Note 7

An information processing program for causing at least one processor to execute

first prompt generation processing of generating a first prompt for requesting to answer a question and providing the generated first prompt to a large-scale language model,

first message acquisition processing of acquiring a first message representing an answer to the question from the large-scale language model as a response to the first prompt,

second prompt generation processing of generating a second prompt for requesting to re-answer the question using a reasonable inference method and providing the generated second prompt to the large-scale language model, and

second message acquisition processing of acquiring a second message representing a re-answer to the question from the large-scale language model as a response to the second prompt.

### Supplementary Note 8

An information processing system including

a large-scale language model, and

an information processing apparatus,

in which the information processing apparatus includes a first prompt generation means for generating a first prompt for requesting to answer a question and providing the generated first prompt to a large-scale language model, a first message acquisition means for acquiring a first message representing an answer to the question from the large-scale language model as a response to the first prompt, a second prompt generation means for generating a second prompt for requesting to re-answer the question using a reasonable inference method and providing the generated second prompt to the large-scale language model, and a second message acquisition means for acquiring a second message representing a re-answer to the question from the large-scale language model as a response to the second prompt.

### Supplementary Information 2

The present disclosure includes the techniques described in the following Supplementary Notes. However, the present disclosure is not limited to the techniques described in the following Supplementary Notes, and various modifications may be made within the scope described in the claims.

### Supplementary Note 1

An information processing apparatus including at least one processor, the at least one processor executing

first prompt generation processing of generating a first prompt for requesting to answer a question and providing the generated first prompt to a large-scale language model,

first message acquisition processing of acquiring a first message representing an answer to the question from the large-scale language model as a response to the first prompt,

second prompt generation processing of generating a second prompt for requesting to re-answer the question using a reasonable inference method and providing the generated second prompt to the large-scale language model, and

second message acquisition processing of acquiring a second message representing a re-answer to the question from the large-scale language model as a response to the second prompt.

The information processing apparatus may further include a memory. The memory may store a program for causing the at least one processor to execute each processing.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one storage medium configured to store instructions; and
at least one processor configured to execute the instructions to:
generate a first prompt for requesting to answer a question and provide the generated first prompt to a large-scale language model;
acquire a first message representing an answer to the question from the large-scale language model as a response to the first prompt;
generate a second prompt for requesting to re-answer the question using a reasonable inference method and provide the generated second prompt to the large-scale language model;
acquire a second message representing a re-answer to the question from the large-scale language model as a response to the second prompt;
determine stability of inference for deriving a re-answer to the question from variation in re-answers represented by each of a plurality of second messages obtained by repeatedly executing a session including provision of a first prompt, acquisition of a first message, provision of a second prompt, and acquisition of a second message; and
change a value of a temperature parameter of the large-scale language model prior to each of the plurality of sessions.

2. The information processing apparatus according to claim 1, wherein the at least one processor is further configured to execute the instructions to:
provide, to the large-scale language model, each of a plurality of pieces of information different from each other indicating inference processing of deriving an answer to the question prior to each of the plurality of sessions.

3. The information processing apparatus according to claim 1, wherein the at least one processor is further configured to execute the instructions to:
generate, in a case where the stability of inference is determined to be low, for a re-answer represented by each of the plurality of second messages, a third prompt for requesting to answer the question using a reasonable inference method, the third prompt including the question and the re-answer and provide the third prompt to the large-scale language model or another large-scale language model different from the large-scale language model;
acquire, in a case where the stability of inference is determined to be low, for a re-answer represented by each of the plurality of second messages, a third message representing an answer to the question from the large-scale language model or the another large-scale language model as a response to the third prompt including the question and the re-answer; and
decide a final answer to the question based on an answer represented by each of a plurality of third messages obtained by repeating provision of a third prompt and acquisition of a third message.

4. An information processing method, wherein at least one processor includes
first prompt generation processing of generating a first prompt for requesting to answer a question and providing the generated first prompt to a large-scale language model;
first message acquisition processing of acquiring a first message representing an answer to the question from the large-scale language model as a response to the first prompt;
second prompt generation processing of generating a second prompt for requesting to re-answer the question using a reasonable inference method and providing the generated second prompt to the large-scale language model;
second message acquisition processing of acquiring a second message representing a re-answer to the question from the large-scale language model as a response to the second prompt;
stability determination processing of determining stability of inference for deriving a re-answer to the question from variation in re-answers represented by each of a plurality of second messages obtained by repeatedly executing a session including provision of a first prompt by the first prompt generation processing, acquisition of a first message by the first message acquisition processing, provision of a second prompt by the second prompt generation processing, and acquisition of a second message by the second message acquisition processing; and
temperature parameter change processing of changing a value of a temperature parameter of the large-scale language model prior to each of the plurality of sessions.

5. A non-transitory computer-readable medium stored with an information processing program for causing at least one processor to execute:
first prompt generation processing of generating a first prompt for requesting to answer a question and providing the generated first prompt to a large-scale language model;
first message acquisition processing of acquiring a first message representing an answer to the question from the large-scale language model as a response to the first prompt;
second prompt generation processing of generating a second prompt for requesting to re-answer the question using a reasonable inference method and providing the generated second prompt to the large-scale language model;
second message acquisition processing of acquiring a second message representing a re-answer to the question from the large-scale language model as a response to the second prompt;
stability determination processing of determining stability of inference for deriving a re-answer to the question from variation in re-answers represented by each of a plurality of second messages obtained by repeatedly executing a session including provision of a first prompt by the first prompt generation processing, acquisition of a first message by the first message acquisition processing, provision of a second prompt by the second prompt generation processing, and acquisition of a second message by the second message acquisition processing; and
temperature parameter change processing of changing a value of a temperature parameter of the large-scale language model prior to each of the plurality of sessions.
